(19) United States
(12) Patent Application Publication
(10) Pub. No.: US 2009/0165369 A1
(43) Pub. Date: Jul. 2, 2009

(54) METHODS AND COMPOSITIONS FOR MULTI-LAYER NANOPARTICLES

(76) Inventors: Claudia Catalina Luhrs, Rio Rancho, NM (US); Jonathan Phillips, Rio Rancho, NM (US)

Correspondence Address: MH2 TECHNOLOGY LAW GROUP, LLP, 1951 KIDWELL DRIVE, SUITE 550, TYSONS CORNER, VA, 22182, US

(21) Appl. No.: 12/271,361

(22) Filed: Nov. 14, 2008

Related U.S. Application Data
(60) Provisional application No. 60/988,583, filed on Nov. 16, 2007.

(51) Int. Cl. C10L 5/00; B05D 7/00

(52) U.S. Cl. 44/500; 427/214; 977/773

(57) ABSTRACT

Compositions of multi-layer nanoparticies and methods for making the multi-layer nanoparticles are provided. The multi-layer nanoparticle can include a core-shell structure including a core material covered by a multi-layer shell. The multi-layer shelled nanoparticles can be produced using template particles. In one embodiment, the template particle can be provided including a shell layer formed over a core material. One or more other shell layers can then be formed on the template particle and thereby forming a core-shell structured nanoparticle with a diameter of about 1 μm or less.

### RELATED APPLICATIONS

This application claims priority from U.S. Provisional Patent Application Ser. No. 60/988,583, filed Nov. 16, 2007, which is hereby incorporated by reference in its entirety.

### FIELD OF THE INVENTION

This invention relates generally to nanoparticles and, more particularly, to methods and compositions for multi-layer structured nanoparticles.

### BACKGROUND OF THE INVENTION

Solid fuels use various types of solid material as fuel to produce energy and provide heating, which are usually released through combustion. Combustion assemblies and processes for burning solid fuels, such as metal particle fuels, have been used for many years and generally suffer from various problems. For example, the most recent analysis of fractional conversion of chemical potential energy to heat/thrust during a rapid combustion is only about 25%. This is attributed to a variety of diffusion limitations on oxygen diffusion through an in-situ formed metal oxide, and/or oxygen transport to the metal particle surface.

In addition, aluminum is widely used for most conventional solid fuels, where the combustion process does not generate gas. Hence propulsion occurs by heating gas “in the vicinity”. Further, the conventional metal fuels have limited stability in air due to the gradual oxidization or even rapid oxidization of the metal.

Thus, there is a need to provide more advanced metal fuel compositions and synthesis strategies to solve the diffusion problem, the gas generation problem, and the air stability problem in the prior art.

### SUMMARY OF THE INVENTION

According to various embodiments, the present teachings include a multi-layer nanoparticle. The multi-layer nanoparticle can include a core material, a first shell layer disposed over the core material, and a second shell layer disposed over the first shell layer. The core material can include a metal, the first shell layer can include one or more forms of carbon; and the second shell layer can include one or more of a non-conducting material and a semi-conducting material. In addition, the second shell layer or the formed nanoparticle can have a diameter of about 1 μm or less.

According to various embodiments, such multi-layer nanoparticles containing all the elements of fuels/explosives are desired. For example, a multilayer nanoparticle containing (1) a metal layer for releasing energy upon oxidation; (2) a hydrocarbon or pure carbon layer for releasing energy, creating propulsive gas, and providing separation until ignition between metal and oxidizer; and (3) an oxygen containing layer for providing oxygen to ‘burn’ the other two layers, can make an exceptional fuel or explosive material that can be used in all environments. In addition, the disclosed multi-layer nanoparticies can be particularly valuable in oxygen free environments such as in space and in a submarine.

According to various embodiments, the present teachings also include a method for making a multi-layer nanoparticle. The multi-layer nanoparticle can be made by first preparing a template particle to include a first shell layer surrounding a metal core. The first shell layer can include one or more forms of carbon and can then be exposed to a precursor solution to form a second shell layer over the first shell layer. The precursor solution can include a precursor material dissolved in a solvent in an amount such that the formed second shell layer has a diameter of about 1 μm or less.

According to various embodiments, the present teachings further include a method for making a multi-layer nanoparticle. The method can include first preparing a template particle to include a shell layer surrounding a metal core. The shell layer can be in one or more forms of carbon and the template particle can be heated. A precursor solution can then be gradually applied to the heated template particle until a certain amount precursor solution relative to the template particles is applied.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 depicts an exemplary multi-layer nanoparticle in accordance with the present teachings.

FIG. 2 depicts an exemplary method for forming the multi-layer nanoparticle in accordance with the present teachings.

FIGS. 3A-3B depict cross sectional views of an exemplary multi-layer nanoparticle at various stages of formation in accordance with the present teachings.

FIGS. 4A-4B depict cross sectional views of exemplary three-layer nanoparticles in accordance with the present teachings.

### DESCRIPTION OF THE EMBODIMENTS

Reference will now be made in detail to exemplary embodiments of the invention, an example of which is illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary embodiments in which the invention may be practiced. These embodiments are described in sufficient detail to enable those skilled in the art to practice the invention and it is to be understood that other embodiments may be utilized and that changes may be made without departing from the scope of the invention. The following description is, therefore, merely exemplary.

While the invention has been illustrated with respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” The term “at least one of” is used to mean one or more of the listed items can be selected.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume values as defined earlier plus negative values, e.g. −1, −1.2, −1.89, −2, −2.5, −3, −10, −20, −30, etc.

Exemplary embodiments provide compositions of multi-layer nanoparticles and methods for making the multi-layer nanoparticles. Specifically, the multi-layer nanoparticle can include a core-shell structure including a core material covered (or “shelled”) by a multiple shell layers. The disclosed multi-layer nanoparticles can be produced using template particles. For example, the template particle can include a shell layer formed over the core material. One or more other shell layers can then be formed from or on the template particle and thereby form a core-shell structured nanoparticle with a diameter of about 1 μm or less. In various embodiments, the disclosed multi-layer nanoparticles can be used in metal fuels and allow for more efficient use of the metal fuels.

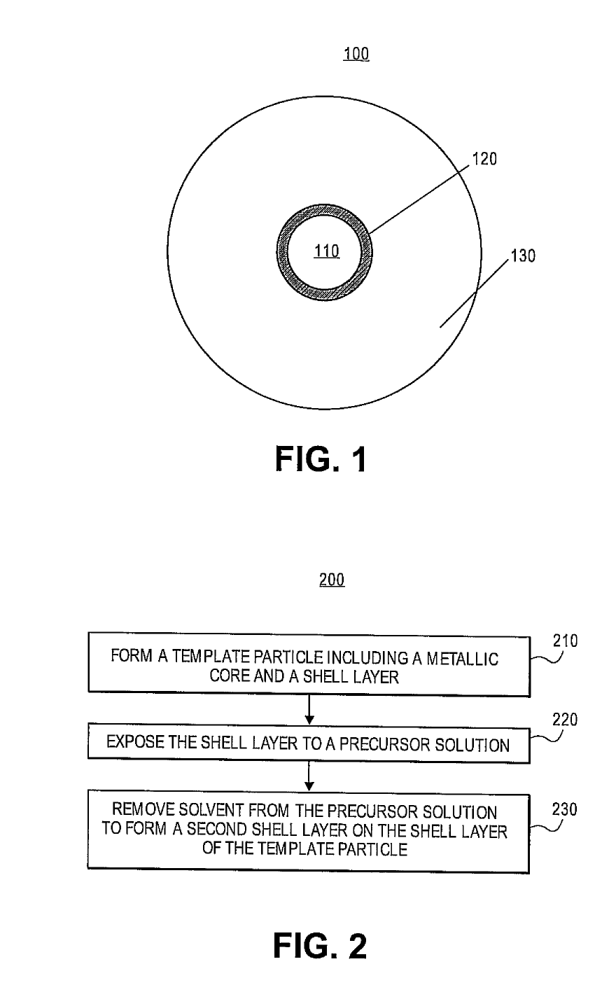

FIG. 1 depicts an exemplary multi-layer nanoparticle 100 in accordance with the present teachings. It should be readily apparent to one of ordinary skill in the art that the nanoparticle 100 depicted in FIG. 1 represents a generalized schematic illustration and that other particles/layers/components can be added or existing particles/layers/components can be removed or modified.

As shown in FIG. 1, the multi-layer nanoparticle 100 can include, e.g., a core material 110, a first shell layer 120 disposed over the core material 110, and a second shell layer 130 disposed over the first shell layer 120.

The core material 110 of the disclosed nanoparticles 100 can include any suitable metal materials that can be used in solid fuels. As used herein, the metal materials used for the core material can include any form of metal(s) from the periodic table, such as, for example, metals, metal compounds, metal alloys, and all possible combinations. In an exemplary embodiment, the core material can include alkali metals such as Li, Na, K, Rb, Cs, and/or Fr, transition metals such as Sc, Ti, V, Cr, Mn, Fe, Co, Ni, Cu, Zn, Y, Zr, Nb, Mo, Tc, Ta, and/or W, noble metals such as Ru, Rh, Pd, Ag, Re, Os, Ir, Pt, and/or Au, other metals such as Al, Ga, Ge, In, Sn, Sb, Ti, Pb, Bi and/or Po, and/or rare earth metals such as Ce, Pr, Nd, Pm, Sm, Eu, Gd, Tb, Dy, Ho, Er, Tm, Yb, Lu, Th, Pa, and/or U.

In various embodiments, the first shell layer 120 can be overlaid (or shelled or surrounded) on the core material 110 and can include, for example, material(s) that include one or more forms of carbon, such as graphite, carbon and/or combinations thereof. The first shell layer 120 can be a protective layer and can have a diameter of about 1 nm or greater.

The second shell layer 130 can be overlaid, shelled or surrounded on the first shell layer 120 and can include one or more materials that are non-conducting and/or semi-conducting, such as, for example, SiO₂, Si, Al₂O₃, TiO₂, Fe₂O₃, Fe₃O₄, Ge, Ge-oxides, or a perchlorate, such as ammonia perchlorate. In various embodiments, the second shell layer 130 can include any alkali metal oxide (e.g., potassium oxide ), any alkali earth oxide (e.g., magnesia ), any rare earth oxide, any transition metal oxide (e.g., iron oxide), any lanthanide oxide (e.g., ceria), any actinide oxide (e.g., UO₃) and/or all possible combinations thereof. In an exemplary embodiment, the second shell layer can include an oxidized form of one or more of Si, Al, Ti, Fe, Ni, Co, Ce, Pr, Nd, Th, Pa, Ge, Sn, Bi and/or combinations thereof.

In various embodiments, the multi-layer nanoparticles 100 can have a diameter of, e.g., about 1 μm or less. In some embodiments, the exemplary multi-layer nanoparticle 100 in FIG. 1 can have a diameter of about 500 nm or less, such as about 50 nm. Various diagnostic techniques, such as, for example, selected area diffraction, energy dispersive spectroscopy (EDX) and transmission electron microscope (TEM) imaging, x-ray diffraction (XRD), and direct measurement of the crystal lattice observed in the transmission electron microscopy (TEM), can be used to characterize the disclosed multi-layer nanoparticle(s).

When producing the disclosed multi-layer nanoparticles, template particles, e.g., template nanoparticles, can be used. For example, the multi-layer nanoparticles can be produced using a multi-step process by first preparing template particles that have a diameter of, for example, about 1 nm or greater. The template particles can then be exposed to a precursor solution followed by removal of solvent from the precursor solution to form a shell layer thereover, and thereby forming multi-layer nanoparticles. In various embodiments, more shell layers can be formed over the formed shell layer over the template particle to form the multi-layer nanoparticle by repeating the step of exposing to various controlled precursor solutions and removing solvent from the precursor solution.

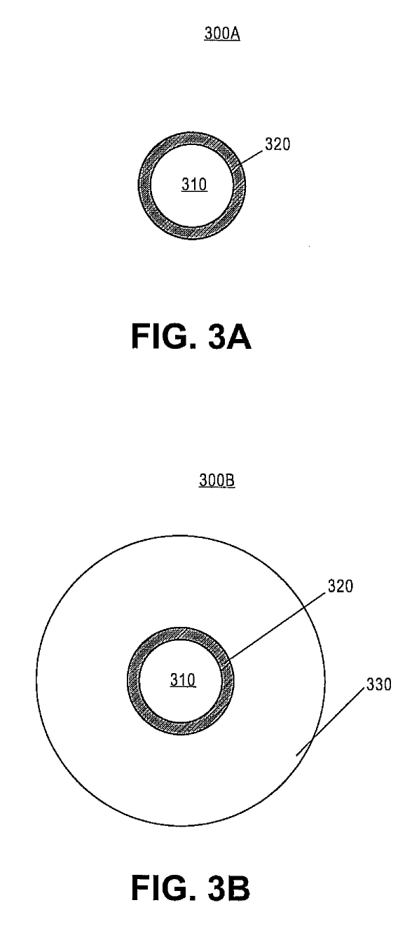

FIG. 2 depicts an exemplary method for forming the multi-layer nanoparticle in accordance with the present teachings, while FIGS. 3A-3B depict cross sectional views of an exemplary multi-layer nanoparticle at various formation stages based on the method 200 depicted in FIG. 2 in accordance with the present teachings.

Note that although the method 200 will be described in reference to FIGS. 3A-3B for illustrative purposes, the process of method 200 is not limited to the structures shown in FIGS. 3A-3B. In addition, while the method 100 of FIG. 1 is illustrated and described below as a series of acts or events, it will be appreciated that the present invention is not limited by the illustrated ordering of such acts or events

At 210 of FIG. 2, a template nanoparticle can be prepared, as indicated in FIG. 3A, including a core-shell structure 300A that includes a first shell layer 320 formed over a core material 310 The core material 310 can have one or more metals or metal alloys as disclosed herein.

The template particle 300A including the first layer 320 over the core material 310 can be formed using various techniques. For example, a high temperature system can be used to form a template particle including a metal core and a graphite outer shell.

The template particles 300A (or the first layer of the formed template particles) can have a diameter, for example, ranging from about 1 nm to about 1000 nm. In an exemplary embodiment, the template particles can have an average diameter of about 50 nm. In various embodiments, the exemplary core structure (e.g., 310 of FIG. 3A) can cover about 70% to about 100% in diameter of the template particle, and the exemplary graphite layer can account for the rest of the template particle. Additional information about the template particles that include graphitic structures can be found in related U.S. patent application, Ser. No. 11/364980, entitled “Preparation of Graphitic Articles,” which is hereby incorporated by reference in its entirety. The prepared template particles (e.g., the carbon coated metal core material) can be used to form multi-layer nanoparticles.

At 220 of FIG. 2, the prepared template particle 300A can be exposed to a controlled precursor solution.

The controlled precursor solution can contain a solvent, such as water or alcohol, with an appropriate amount of dissolved precursor material(s), such as salts or soluble organic compounds. As used herein, the term “appropriate amount” of the dissolved precursor material(s) refers to an amount (e.g., concentration) of the dissolved material in the solvent for producing a second shell layer 330 (see FIG. 3B) on the template particle 300A to form a multi-layer nanoparticle that has a resulting diameter, for example, equal or less than N times (e.g., N is any number) of the average diameter of the template particles 300A. In an exemplary embodiment where N is 0.5, if the template particles have an average diameter of about 40 nm, the controlled appropriate amount of the dissolved precursor material(s) can be the amount needed for producing the second shell layer (and thus the resulting nanoparticle) to have a total particle diameter of about 60 nm.

In various embodiments, it is crucial to control the total particle diameter of the disclosed multi-layer nanoparticles according to specific applications. For example, fuel particles may require a stoichiometric ratio between oxygen in the outer shell and metal in the core. The total particle diameter of the multi-layer nanoparticles or the thickness of the exemplary oxide shell layer can be controlled by this stoichiometric ratio.

In various embodiments, the precursor materials used in the controlled precursor solution can include any materials used for forming non-conducting and/or semi-conducting layers of, such as, for example, SiO₂, Si, Al₂O₃, TiO₂, Fe₂O₃, Fe₃O₄, Ge, Ge-oxides, or a perchlorate, such as ammonia perchlorate. Particularly, the precursor materials can include, such as, for example, metal salts, molten metals, calcogenides or metal alcoxides as desired. For example, tetraehyleorthosilicate (TEOS) can be used as the precursor material for forming a silica layer and aluminum nitrate can be used as the precursor material for forming an alumina layer.

In various embodiments, the prepared template particles can first be heated to and kept at a desired temperature prior to the application of the controlled precursor solution. While heating, a precursor solution can be gradually applied (e.g., added) to the heated template particles 300A. As used herein, the term “gradually apply” refers to an alternating process for applying the precursor solution to the heated template particles. The alternating process can include adding drops of the precursor solution to wet the heated template particles, alternating with observing the disappearance of the added drops, until a certain amount of precursor solution relative to the size of the template particles has been added.

At 230 of FIG. 2, following the application of the controlled precursor solution to the template particles 300A, the solvent of the precursor solution can then be removed from the precursor solution and thereby forming the second shell layer 330 (see FIG. 3B) over the template particle 300A, particularly, over the first shell layer 320 thereof. In various embodiments, the second shell layer 330 can also be referred to herein as “a third layer” of the multi-layer nanoparticle, wherein the core material is a first layer of the multi-layer nanoparticle, the first shell layer is a second layer of the multi-layer nanoparticle and the second shell layer 330 is a third layer of the multi-layer nanoparticle. To remove the solvent, various techniques can be used including, but not limited to, heating, evaporation, or vacuum processes that are known to one of ordinary skill in the art. In various embodiments, each template particle can be equally and uniformly coated.

In an exemplary embodiment, prepared template particles from 210 of FIG. 2 can be put into a beaker (e.g., 50 cc), open to the ambient air, and placed on a hot plate until a steady temperature of about 275° C. to about 300° C. is reached. Meanwhile, several drops of precursor solution, such as a common liquid reagent containing tetraehyleorthosilicate (TEOS), can be added and observed (e.g., by eye) to wet the template particles (see 300A) as bulk. After the liquid reagent is observed to disappear (e.g., taking about 2 minutes), more drops can be added to the template particles being heated. The process can be repeated until a total TEOS of, e.g., about 1.2 ml, is added. In addition, the entire process can take, for example, about 15 minutes, to form the second shell layer (see 330) over the first shell layer (see 320) of the template nanoparticle. The produced multi-layer nanoparticles can then be removed from the heat and/or examined using a variety of techniques.

In various embodiments, one or more shell layers can be formed over the second shell layer 330 over the template particle 300A by repeating the step of exposing to various controlled precursor solutions and removing solvents from the precursor solutions

In an exemplary embodiment, the multi-layer nanoparticle(s) can include a metal core material, such as Sn (tin), covered by a first shell layer of carbon, partially graphitized, fully graphitized, or amorphous. The exemplary carbon or graphitized carbon shell layer can further be covered by a second shell layer of, for example, silica or alumina.

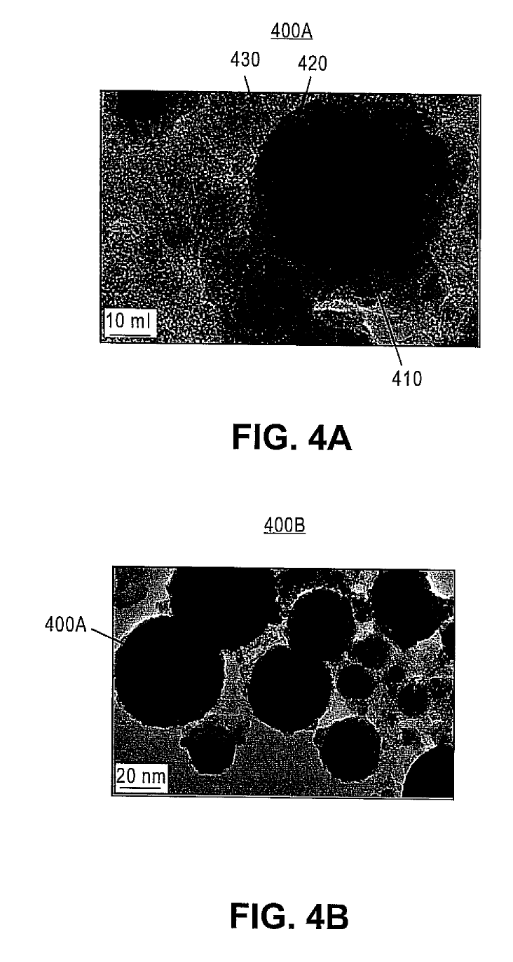

For example, FIGS. 4A-4B depict cross sectional views of exemplary three-layer nanoparticles in accordance with the present teachings. It should be readily apparent to one of ordinary skill in the art that the nanoparticles 400 depicted in FIGS. 4A-4B represent a generalized schematic illustration and that other particles/layers/components can be added or existing particles/layers/components can be removed or modified.

As shown in FIG. 4A, the exemplary three-layer nanoparticle 400A can include an exemplary core material 410 of Tin, an exemplary first shell layer 420 of graphitized carbon and an exemplary second shell layer 430 of alumina. FIG. 4B shows a plurality of three-layer nanoparticles that have an average particle size of about 50 nm.

In various embodiments, the disclosed multi-layer nanoparticles can be used in metal fuels, and in certain embodiments, can be used in environments where oxygen is not readily available, for example, in space or in a submarine; and where the fuel and an oxygen supply must be carried separately. When used, the fuel and the oxygen supply must be mixed. In addition, given the need to ‘flow’ materials together, at least one element of the fuel or explosive systems is required to be fluidic, such as being as liquid or a gas. Further, for energy dense fuels (e.g. aluminum metal), there is no direct production of a propellant gas. Moreover, the requirement of bringing different components together and then generating the propulsive gas requires complex engineering.

As disclosed, the use of multi-layer nanoparticles can eliminate the need for mixing and can directly generate a propulsive gas, which can reduce engineering complexity and concomitantly reduce the volume and weight of the control system. In addition, the use of the multi-layer nanoparticles can be inherently safer, simpler and more efficient at delivering energy as compared with conventional fuels.

In various embodiments, the disclosed multi-layer nanoparticles can further allow for more efficient use of the metal fuels For example, oxygen diffusion limitations can first be reduced by a reduced length scale (e.g., about 20 nanometers) of the diffusion barrier oxide created during the combustion process of the multi-layer nanoparticles. Second, diffusion of oxygen to the metal core can not be limited, because the oxygen is included in the multi-layer nanoparticles (e.g., in the second shell layer 130 of FIG. 1 or 330 of FIG. 3). Third, the combustion process of the multi-layer nanoparticles can produce gas. Specifically, when the protective carbon layer (i.e., the first shell layer 120 or 320 of the nanoparticles 100 or 300B) burns during the combustion process, it can produce gas (e.g., CO₂). Finally, the disclosed nanoparticles can be more stable in storage than ordinary metal fuels in the art. This is because the carbon shell can prevent the metal core and the oxygen (e.g., in the oxidizer layer) from combining, and both the oxidizer layer and the carbon layer can keep the atmospheric oxygen from reaching the metal core.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A multi-layer nanoparticle comprising:
a core material comprising a metal;
a first shell layer disposed over the core material, wherein the first shell comprises one or more forms of carbon; and
a second shell layer disposed over the first shell layer, wherein the second shell layer has a diameter of about 1 μm or less and comprises one or more of a non-conducting material and a semi-conducting material.

2. The nanoparticle of claim 1, wherein the metal for the core material comprising one or more metals or metal alloys of an alkali metal, an alkali earth, a transition metal, a lanthanide or an actinide.

3. The nanoparticle of claim 1, wherein the metal for the core material comprising one or more metals of Li, Na, K, Rb, Cs, Sc, Ti, V, Cr, Mn, Ru, Rh, Pd, Ag, Re, Al, Fe, Ni, Co, Ga, Ge, In, Sn, Ce, Pr, Nd, Pm, Sm, or combinations thereof.

4. The nanoparticle of claim 1, wherein the first shell layer comprises a graphite.

5. The nanoparticle of claim 1, wherein the first shell layer has a diameter of about 1 nm or higher.

6. The nanoparticle of claim 1, wherein the second shell layer comprises an oxidized form of one or more of an alkali metal, an alkali earth, a rare earth, a transition metal, a lanthanide, an actinide or combinations thereof.

7. The nanoparticle of claim 1, wherein the second shell layer comprises an oxidized form of one or more of Si, Al, Ti, Fe, Ni, Co, Ce, Pr, Nd, Th, Pa, Ge, Sn, Bi, ammonia perchlorate or combinations thereof.

8. The nanoparticle of claim 1, further comprising
a tin core;
a first shell layer disposed over the tin core, wherein the first shell is a graphitized carbon; and
a second shell layer disposed over the first shell layer, wherein the second shell layer has a diameter of about 1 μm or less and comprises one or more of a silica and an alumina.

9. A method for making a multi-layer nanoparticle comprising:
preparing a template particle, wherein the template particle comprises a metal core and a first shell layer that comprises one or more forms of carbon; and
exposing the template particle to a precursor solution to form a second shell layer over the first shell layer, wherein the precursor solution comprises a precursor material dissolved in a solvent in an amount such that the formed second shell layer has a diameter of about 1 μm or less.

10. The method of claim 9, further comprising removing the solvent from the precursor solution to form the second shell layer over the first shell layer of the template particle.

11. The method of claim 9, further comprising controlling the amount of the precursor material such that the formed second shell layer has a diameter equal or less than N times of a diameter of the template particle, wherein N is any number.

12. The method of claim 9, wherein the precursor material comprises one or more materials of a metal salt, a metal alkoxide or a calcogenide.

13. The method of claim 9, wherein the precursor material is tetraehyleorthosilicate (TEOS) or aluminum nitrate.

14. The method of claim 9, wherein the template particle is formed having a diameter of about 1 nm to about 1000 nm.

15. The method of claim 9, wherein the template particle is formed to have the metal core covering about 70% to about 100% in diameter of the template particle.

16. The method of claim 9, further comprising controlling a diameter of the second shell layer by a stoichiometric ratio between oxygen in the second shell layer and metal in the metal core.

17. A multi-layer nanoparticle formed using the method of claim 9.

18. A method for making a multi-layer nanoparticle comprising:
preparing a template particle, wherein the template particle comprises a metal core and a shell layer that comprises one or more forms of carbon; and;
gradually applying a precursor solution to the template particle until a certain amount of precursor solution relative to the template particles is applied to the shell layer of the template particle.

19. The method of claim 18, further comprising removing a solvent from the precursor solution while gradually applying the precursor solution to the template particle.

20. The method of claim 18, further comprising:
removing a solvent from the gradually applied precursor solution to form a first layer over the template particle; and
gradually applying a second precursor solution to the first layer over the template particle to from a second layer over the first layer over the template particle.

21. The method of claim 19, further comprising forming one or more additional layers over the second layer that is formed over the first layer.

22. A multi-layer nanoparticle formed using the method of claim 18.
